(19) United States
(12) Patent Application Publication
(10) Pub. No.: US 2025/0340174 A1
(43) Pub. Date: Nov. 6, 2025

(54) MODULAR MOUNT SYSTEM

(71) Applicants: Russell A. Pinsky, Crystal Lake, IL (US); SpecGate, LLC, Incline Village, NV (US)

(72) Inventors: Jason Seaver, Incline Village, NV (US); Russell A. Pinsky, Crystal Lake, IL (US)

(21) Appl. No.: 19/195,710

(22) Filed: Apr. 30, 2025

Related U.S. Application Data
(60) Provisional application No. 63/641,625, filed on May 2, 2024.

(51) Int. Cl. B60R 9/06; B60R 3/00; B60R 11/00; B60R 11/06

(52) U.S. Cl. CPC B60R 9/06; B60R 3/00; B60R 11/06; B60R 2011/004; B60R 2011/0066; B60R 2011/007; B60Y 2200/141

(57) ABSTRACT

A modular mount system for a vehicle, the modular mount system including a base gate and a modular accessory. The base gate is attachable to a movable component of the vehicle. The base gate includes a mounting interface. The modular accessory is configured to be removably attached to the mounting interface. The modular accessory is movable within the mounting interface to multiple positions along the mounting interface.

### CROSS REFERENCE TO RELATED APPLICATION

This application claims the benefit of and priority to U.S. Provisional Patent Application No. 63/641,625, filed May 2, 2024, and titled “MODULAR MOUNT SYSTEM”. The entire contents of the foregoing application are hereby incorporated by reference herein for all purposes.

### FIELD OF THE INVENTION

The present disclosure relates to a mount system, and more specifically to a mount system for use with a vehicle.

### SUMMARY

The present disclosure provides, in one aspect, a modular mount system for a vehicle. The modular mount system includes a base gate and a modular accessory. The base gate is attachable to a movable component of the vehicle. The base gate includes a mounting interface. The modular accessory is configured to be removably attached to the mounting interface.

In some aspects, the mounting interface is a first mounting interface, and the base gate further includes a length extending along a length direction, a width extending along a width direction, and a second mounting interface. The modular accessory is configured to be removably attached to both the first mounting interface and the second mounting interface. The second mounting interface is spaced from the first mounting interface along one of the length direction and the width direction.

In some aspects, the base gate includes a base gate body that defines a guide receptacle and a guide that is received in the guide receptacle. The guide includes the mounting interface. In further aspects, the mounting interface includes a first edge, a second edge, and a guide slot defined between the first edge and the second edge. The guide slot slidably receives a mounting adapter that is configured to slide along the guide slot. The modular accessory is configured to be removably attached to the mounting adapter such that the modular accessory is configured to slide along the guide slot with the mounting adapter. In even further aspects, the modular accessory includes an actuator that is configured to be tightened to inhibit movement of the mounting adapter along the guide slot. In other aspects, the guide is removably attached to the base gate body within the guide receptacle via fasteners. In other aspects, the guide is one of a plurality of guides. Each guide of the plurality of guides includes a mounting interface, and the mounting interface of each of guide of the plurality of guides is configured to receive the modular accessory. In further aspects, at least one of the guides of the plurality of guides is longer than another of the guides of the plurality of guides.

In some aspects, the vehicle is a truck including a truck bed, and the movable component is a tailgate of the truck bed.

In some aspects, the base gate includes base gate body that defines an accessory plate receptacle and an accessory plate that is configured to be received in the accessory plate receptacle. A bottom surface of the accessory plate receptacle defines at least one magnetic aperture configured to receive at least one magnet that creates a magnetic field such that accessories are attachable to the accessory plate via a magnetic connection.

In another aspect, the disclosure provides a modular mount system for a vehicle. The modular mount system includes a base gate and a modular accessory. The base gate is attachable to the vehicle. The base gate includes a mounting interface that extends along a first direction of the base gate. The modular accessory is movable within the mounting interface to multiple positions along the first direction of the base gate.

In further aspects, the modular accessory includes a lock that is configured to secure the modular accessory in each of the multiple positions along the first direction of the base gate such that the lock inhibits movement of the modular accessory within the mounting interface. In other aspects, the deployed position includes any position of the modular accessory in which the modular accessory has been rotated between 0 and 360 degrees relative to the storage position.

In some aspects, the mounting interface is a first mounting interface, and the base gate further includes a second mounting interface that is spaced from the first mounting interface along a second direction of the base gate. The modular accessory is configured to be attached to both the first mounting interface and the second mounting interface. In further aspects, the base gate further includes a third mounting interface that is spaced from the first mounting interface and the second mounting interface along the first direction of the base gate, and the modular accessory is configured to be movably attached to the third mounting interface.

In another aspect, the disclosure provides a modular mount system for a vehicle. The modular mount system includes a base gate, a first modular accessory, and a second modular accessory. The base gate is attachable to the vehicle. The base gate includes a length, a width, a first mounting interface, and a second mounting interface. The length extends along a length direction. The width extends along a width direction. The first mounting interface extends along the length direction. The second mounting interface extends along the width direction. The first modular accessory is configured to be removably attached to the first mounting interface. The first modular accessory is movable within the first mounting interface to multiple positions along the length direction of the base gate. The second modular accessory is configured to be removably attached to the second mounting interface. The second modular accessory is movable within the second mounting interface to multiple positions along the width direction of the base gate.

In some aspects, the modular mount system further includes a third modular accessory configured to be removably attached to the first mounting interface. The third modular accessory is movable within the first mounting interface to multiple positions along the length direction of the base gate.

In some aspects, the base gate is attachable to a movable component of the vehicle.

### BRIEF DESCRIPTION OF THE DRAWINGS

FIG. 1A is a perspective view of a modular mount system attached to a first user-operated vehicle, according to some embodiments.

FIG. 1B is a perspective view of the modular mount system attached to a second user-operated vehicle, according to some embodiments.

FIG. 2 is a perspective view of the modular mount system including a base gate and a modular accessory in a deployed position, according to some embodiments.

FIG. 3 is a perspective view of the base gate, according to some embodiments.

FIG. 4 is a plan view of the base gate, according to some embodiments.

FIG. 5 is an exploded view of the base gate, according to some embodiments.

FIG. 6 is a schematic view of a guide and a first mounting adapter for the base gate of FIG. 3, according to some embodiments.

FIG. 7A is a perspective view of the first mounting adapter, according to some embodiments.

FIG. 7B is a perspective view of a second mounting adapter for the base gate of FIG. 3, according to some embodiments.

FIG. 8A is a schematic view of the first mounting adapter and the modular accessory including a first actuator, according to some embodiments.

FIG. 8B is a schematic view of the second mounting adapter and the modular accessory including a second actuator, according to some embodiments.

FIG. 9A is a perspective view of a first accessory for the modular mount system, according to some embodiments.

FIG. 9B is a perspective view of a second accessory for the modular mount system, according to some embodiments.

FIG. 10 is a perspective view of a portion of the modular mount system of FIG. 2 with the modular accessory in a storage position, according to some embodiments.

FIG. 11A is a plan view of the modular mount system in a first configuration, according to some embodiments.

FIG. 11B is a plan view of the modular mount system in a second configuration, according to some embodiments.

FIG. 11C is a plan view of the modular mount system in a third configuration, according to some embodiments.

FIG. 11D is a plan view of the modular mount system in a fourth configuration, according to some embodiments.

FIG. 11E is a plan view of the modular mount system in a fifth configuration, according to some embodiments.

FIG. 12A is a top perspective view of the modular mount system in another configuration and attached to vehicle, according to some embodiments.

FIG. 12B is a side perspective view of the modular mount system in the configuration of FIG. 12A and including a modular accessory in a storage position, according to some embodiments.

FIG. 12C is a side perspective view of the modular mount system in the configuration of FIG. 12A and including a modular accessory in a deployed position, according to some embodiments.

FIG. 13 is a perspective view of an alternative base gate, according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The detailed description uses numerical and letter designations to refer to features in the drawings. Like or similar designations in the drawings and description have been used to refer to like or similar parts of the invention.

The singular forms “a,” “an,” and “the” include plural references unless the context clearly dictates otherwise. The terms “coupled,” “fixed,” and the like refer to both direct coupling or fixing, as well as indirect coupling or fixing through one or more intermediate components or features, unless otherwise specified herein. As used herein, the terms “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

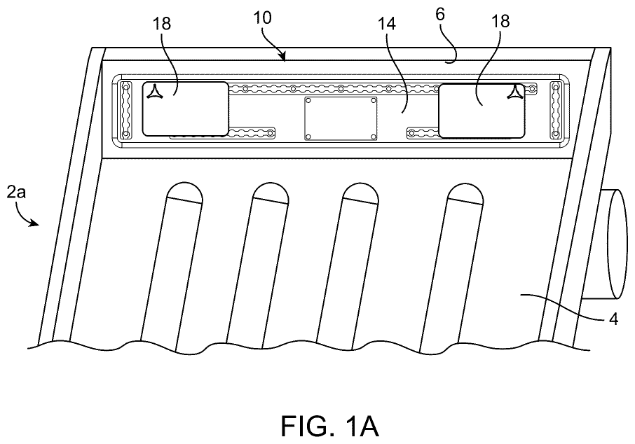

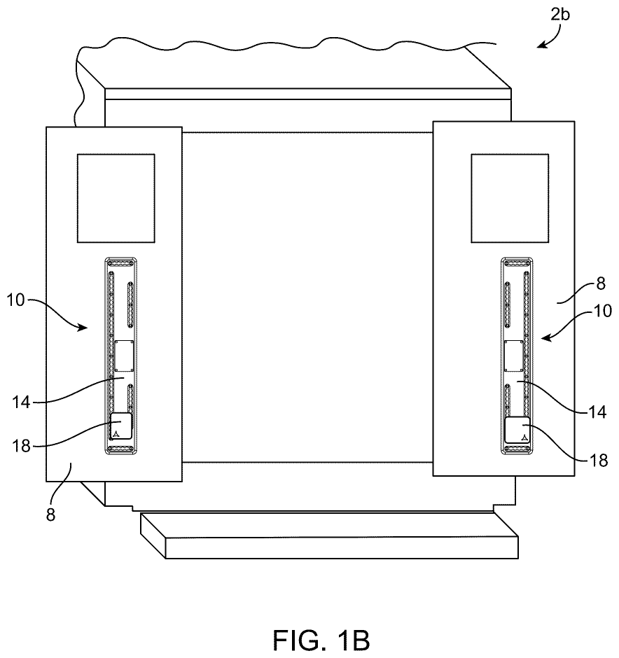

FIGS. 1A and 1B illustrate a modular mount system 10 for use with a user-operated vehicle 2a, 2b, in accordance with some embodiments. For example, as illustrated in FIG. 1A, the user-operated vehicle 2a is a truck, and more specifically, a pick-up truck having a truck bed 4 and a tailgate 6. As illustrated in FIG. 1A, the modular mount system 10 is mounted to an inner (or interior) side of the tailgate 6 of the truck 2a and may be used to attach accessories, as will be described in more detail, to the tailgate 6 to securely optimize storage in the truck bed 4 and improve case of access to the accessories. In some embodiments, the modular mount system 10 may be mounted to a sidewall of the truck bed 4 (e.g., a stationary wall of the truck bed 4 that is adjacent to the tailgate 6). In another embodiment, as illustrated in FIG. 1B, the user-operated vehicle 2b is a van and/or an emergency vehicle (such as but not limited to, an ambulance) including rear doors 8. The modular mount system 10 is mounted to an inner (or interior) side of each of the rear doors 8 to securely optimize storage within the user-operated vehicle 2b and improve case of access to the accessories.

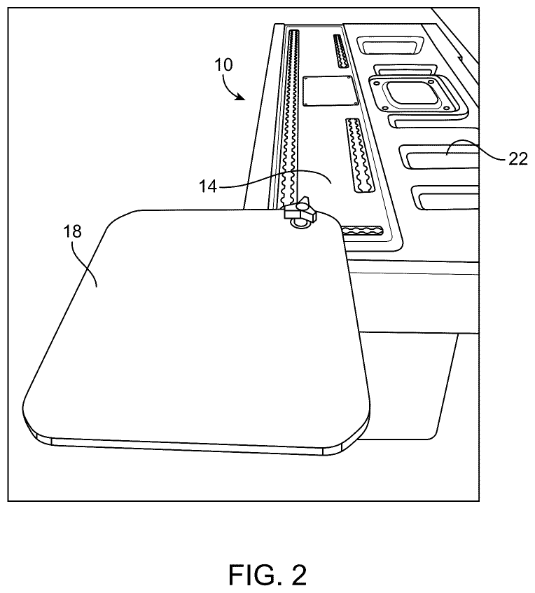

As illustrated in FIG. 2, the modular mount system 10 may include a base gate 14 and at least one modular accessory 18. The base gate 14 may be selectively and removably mounted to, for example, the tailgate 6 illustrated in FIG. 1A or the rear doors 8 illustrated in FIG. 1B. In the illustrated embodiment, with reference to FIG. 2, the base gate 14 is mounted to a tail gate 22, and the modular accessory 18 is mounted to the base gate 14, as will be described in more detail. In the illustrated embodiment, only one modular accessory 18 is mounted to the base gate 14. However, any number of modular accessories 18 may be mounted to the base gate 14 according to user preference.

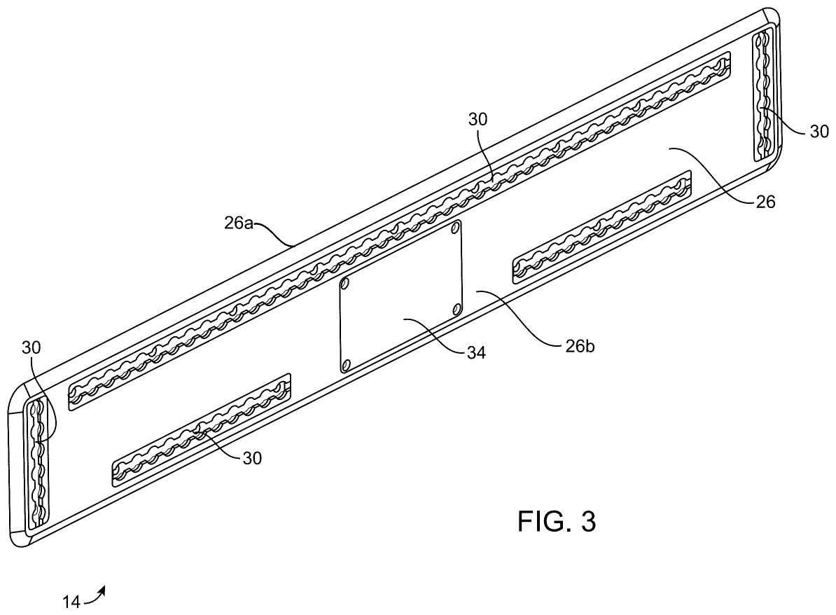

As illustrated in FIGS. 3-5, the base gate 14 includes a base gate body 26, a plurality of guides 30, and an accessory plate 34. The base gate 14 has a length L1 that extends along a length or first direction A1 and a width WI that extends along a width or second direction A2 that is perpendicular to the first direction A1. In the illustrated embodiment, the base gate body 26 is formed from a plastic material such as, but not limited to, high density polyethylene (HDPE). In other embodiments, the base gate body 26 may be formed of other materials such as, but not limited to, a wood material, a metal material (e.g., aluminum, steel, etc.), or a different type of plastic material (e.g., polyethylene terephthalate, low density polyethylene, polyvinyl chloride, etc.). The base gate body 26 has a first or rear side 26a and a second or front side 26b. The rear side 26a of the base gate body 26 is configured to be placed on, for example, the inner side of the tailgate 6 of FIG. 1A or the inner side of the rear doors 8 of FIG. 1B to attach the modular mount system 10 to a user-operated vehicle 2a, 2b. The front side 26b of the base gate body 26 is configured to receive the modular accessory 18 (FIG. 2). The base gate body 26 defines a plurality of apertures 38 that receives a plurality of fasteners 42 that may be used couple the base gate 14 to a user-operated vehicle, a plurality of guide receptacles 46 shaped to receive the plurality of guides 30, and an accessory plate receptacle 50 shaped to receive the accessory plate 34.

Each of the plurality of apertures 38 extends from the front side 26b of the base gate body 26 through the rear side 26a of the base gate body 26. As such, a fastener 42 from the plurality of fasteners 42 may be inserted into a corresponding aperture 38 at the front side 26b of the base gate body 26 and extended through the rear side 26a of the base gate body 26 to attach the base gate 14 to a user-operated vehicle. The base gate 14 may be attached to a user-operated vehicle through other means such as welding. Each of the plurality of apertures 38 may be positioned within, or extend through, a corresponding one of the plurality of guide receptacles 46 or the accessory plate receptacle 50. Specifically, in the illustrated embodiment, the base gate body 26 includes nineteen apertures 38 that are distributed across and positioned within the plurality of guide receptacles 46 and four apertures 38 that are positioned at a respective corner of the accessory plate receptacle 50.

The plurality of guide receptacles 46 includes five guide receptacles 46 that extend linearly along the base gate body 26. The plurality of guide receptacles 46 may be formed (e.g., machined) into the front side 26b of the base gate body 26. In the illustrated embodiment, three of the guide receptacles 46 are formed in the base gate body 26 along the first direction A1 and two of the guide receptacles 46 are formed in the base gate body 26 along the second direction A2. In some embodiments, fewer or more guide receptacles 46 may be formed along the first direction A1, and fewer or more guide receptacles 46 may be formed along the second direction A2. In other embodiments, some of the guide receptacles 46 may be formed along third or fourth directions that extend at an angle relative to the first and second directions A1, A2. Some of the guide receptacles 46 are relatively longer than the other guide receptacles 46. As such, more apertures 38 are distributed, or positioned, within the relatively larger guide receptacles 46 than the relatively smaller guide receptacles 46.

With continued reference to FIGS. 3-5, in the illustrated embodiment the accessory plate receptacle 50 is positioned at a center of the base gate body 26. However, in other embodiments, the accessory plate receptacle 50 may be positioned off-center of the base gate body 26. The accessory plate receptacle 50 is formed (e.g., machined) into the front side 26b of the base gate body 26. The accessory plate receptacle 50 may be formed from the same process or a different process as the guide receptacles 46. As such, the accessory plate receptacle 50 may be formed simultaneously with or separately from the guide receptacles 46. In some embodiments, the base gate body 26 may be formed from a molding (e.g., injection molding) process that directly forms the guide receptacles 46 and the accessory plate receptacle 50 into the base gate body 26. The accessory plate receptacle 50 includes a plurality of magnet apertures 54. Specifically, the accessory plate receptacle 50 includes four magnet apertures 54 that are recessed from a bottom surface 50a of the accessory plate receptacle 50. Each of the magnet apertures 54 is configured to receive a magnet 58 that creates a magnetic field at the center of the base gate body 26. In other embodiments, the accessory plate receptacle 50 may include fewer or more magnet apertures 54 to adjust the strength of the magnetic field created by the magnets 58.

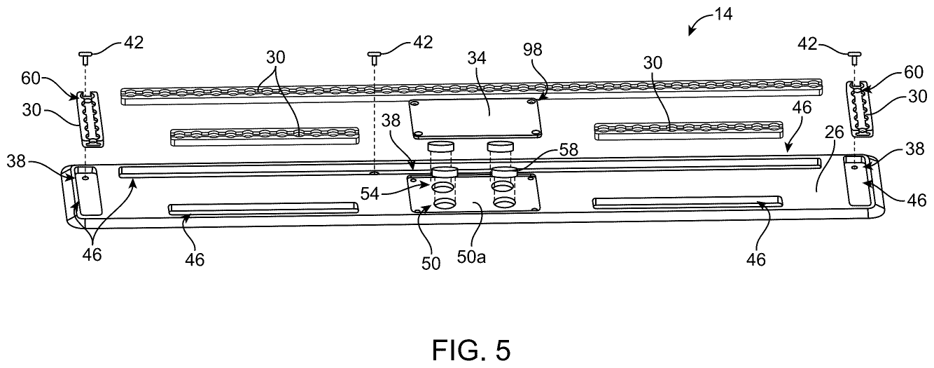

As illustrated in FIG. 5, the plurality of guides 30 may include five guides 30. Each of the five guides 30 is shaped to be inserted into a corresponding one of the guide receptacles 46. Each of the plurality of guides 30 defines a plurality of guide apertures 60. Specifically, each of the guides 30 defines at least one guide aperture 60 of the plurality of guide apertures 60. The guides 30 may be inserted into the guide receptacles 46 such that each of the plurality of guide apertures 60 aligns with a respective one of the plurality of apertures 38 defined in the guide receptacles 46. Therefore, a fastener 42 may be inserted into each of the guide apertures 60 and each of the apertures 38 defined in the guide receptacles 46 of the base gate body 26 to couple each of the guides 30 to the base gate body 26 within a corresponding guide receptacle 46. With the exception of length and orientation, the guides 30 may be identical to one another.

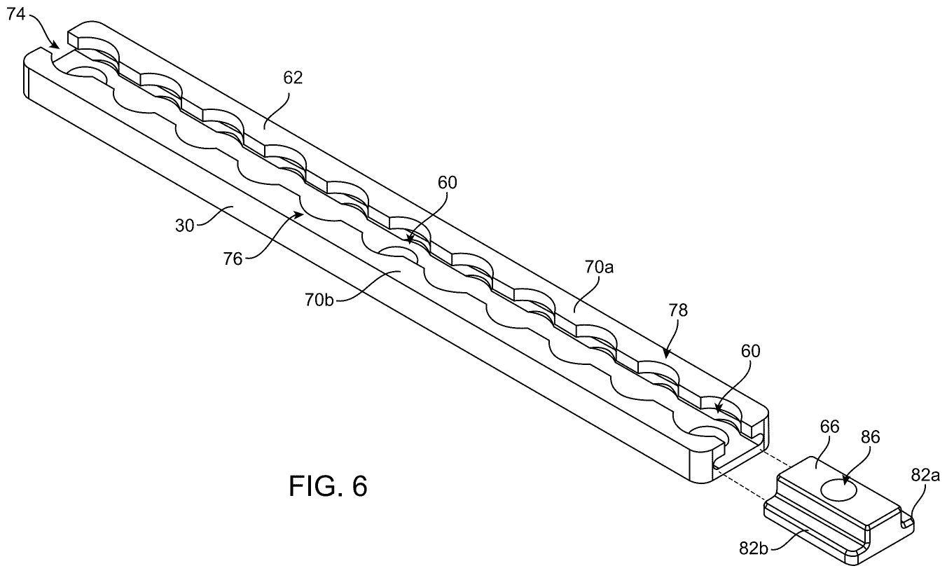

As illustrated in FIG. 6, each of the guides 30 includes a mounting interface 62 configured to slidably receive a mounting adapter 66. In the illustrated embodiment, the mounting interface 62 includes a first edge 70a and a second edge 70b that define a guide slot 74 therebetween. Each of the first edge 70a and the second edge 70b defines a plurality of half-moon recesses 78. The half-moon recesses 78 are defined along the length of each of the edges 70a, 70b. Each of the half-moon recesses 78 on one of the edges 70a, 70b faces a half-moon recess 78 on the other of the edges 70a, 70b of the guide 30. In the illustrated embodiment, the guide slot 74 extends along the entire length of the guide 30. In other embodiments, the guide slot 74 may only extend along a portion of the length of the guide 30.

In some embodiments, the guides 30 may have other designs and features. For example, the guides 30 may include indicia along the edges 70a, 70b. The indicia may include markings indictive of the imperial system. That is, the indicia may include markings indicative of a measurement in inches. Alternatively, the indicia may include markings indicative of the metric system. That is, the indicia may include markings indicative of a measurement in millimeters and/or centimeters. It is readily understood that other similar indicia may be provided on the guides 30. In other embodiments, the guides 30 may not include the half-moon recesses 78. In such embodiments, the edges 70a, 70b may have other shapes.

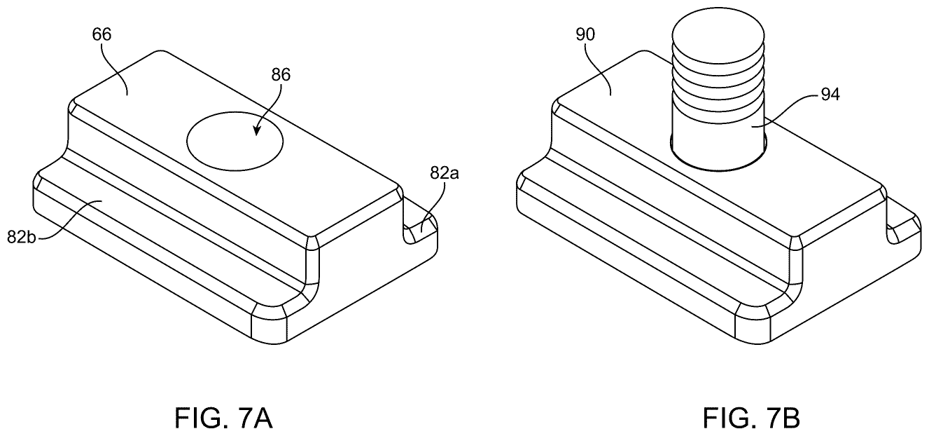

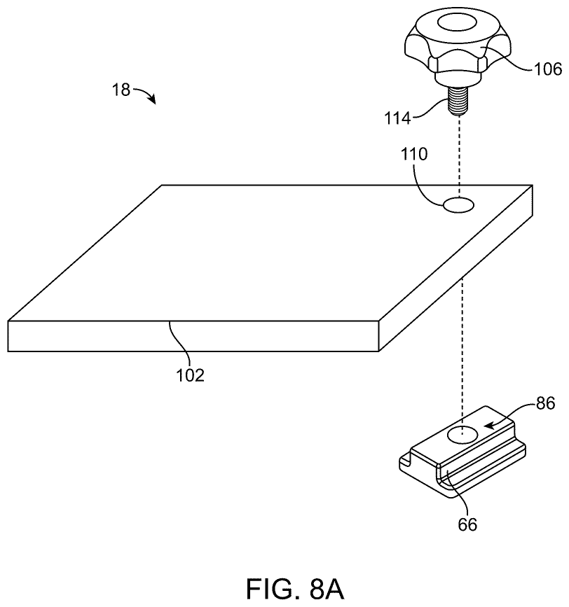

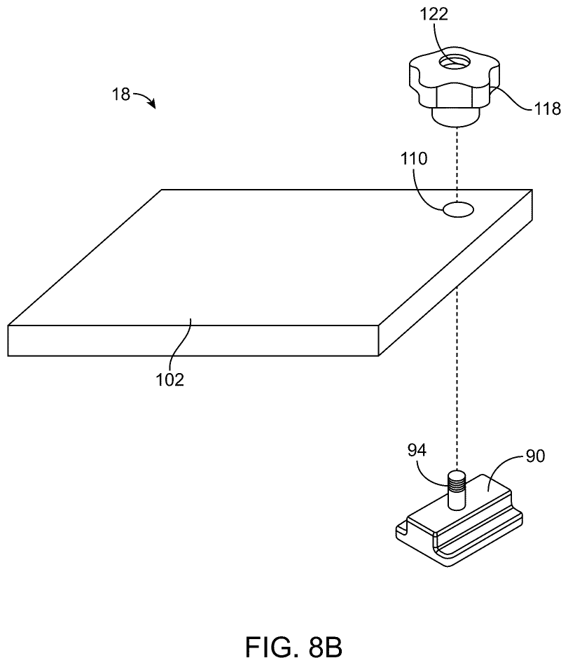

With reference to FIGS. 2, 6, and 7A, the mounting adapter 66 includes a first flange 82a that is configured to slide along the first edge 70a and a second flange 82b that is configured to slide along the second edge 70b. The mounting adapter 66 is configured to threadedly couple with the modular accessory 18 to couple the modular accessory 18 to a respective one of the guides 30, and therefore, to the base gate 14. In the illustrated embodiment, as illustrated in FIG. 8A, the mounting adapter 66 defines a female threaded aperture 86 that is configured to receive a portion of the modular accessory 18 to couple the modular accessory 18 to a respective one of the guides 30, and therefore, to the base gate 14. In other embodiments, with reference to FIG. 7B, a mounting adapter 90 including a male threaded stud 94 may be received in the guides 30 for coupling the modular accessory 18 to a respective one of the guides 30.

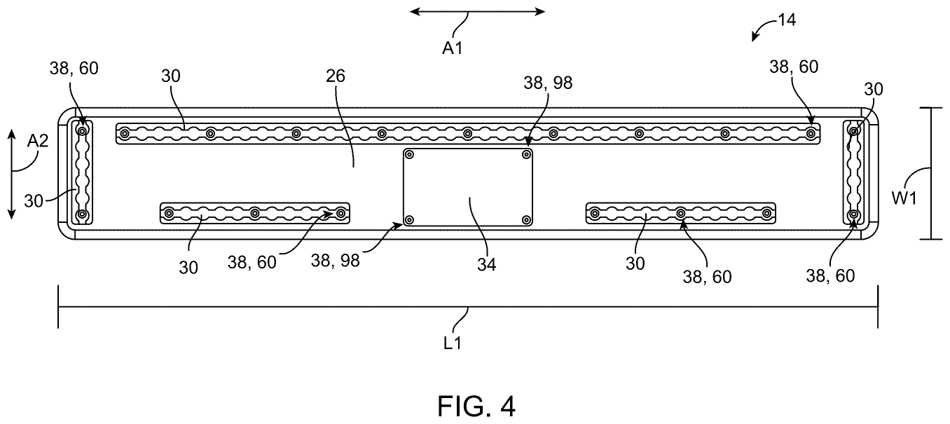

In the illustrated embodiment, with reference to FIGS. 4 and 5, the accessory plate 34 is substantially rectangular and may be formed of a metal material. In other embodiments, the accessory plate 34 may be formed of another material, such as a wood material, or a type of plastic material (e.g., HDPE, polyethylene terephthalate, low density polyethylene, polyvinyl chloride, etc.). The accessory plate 34 is shaped to be inserted into the accessory plate receptacle 50. The accessory plate 34 defines four accessory plate apertures 98. Each of the accessory plate apertures 98 is positioned at a respective corner of the rectangular accessory plate 34. As such, the accessory plate 34 may be inserted into the accessory plate receptacle 50 such that each of the accessory plate apertures 98 aligns with a respective one of the apertures 38 defined in the accessory plate receptacle 50. Therefore, a fastener 42 may be inserted into each of the accessory plate apertures 98 and each of the apertures 38 defined in the accessory plate receptacle 50 of the base gate body 26 to couple the accessory plate 34 to the base gate body 26 within the accessory plate receptacle 50. In embodiments in which the accessory plate 34 is formed of a metal material, the magnets 58 may provide an additional securing means for the accessory plate 34. The magnets 58 may additionally create a magnetic field that is strong enough to magnetically secure accessories and other objects to the accessory plate 34 via a magnetic connection. For example, the magnets 58 may enable a user to attach metal objects such as tool bits, wrenches, and other similar objects to the accessory plate 34.

In some embodiments, the accessory plate 34 may be customizable according to user preference. That is, the accessory plate 34 may be formed with a design on a front-facing side of the accessory plate 34 such that the design is visible when viewing the front side 26b of the base gate body 26. The design may be formed through any means such as metal engraving, painting, wood carving, and the like.

FIG. 8A illustrates one example of the modular accessory 18 configured for use with the base gate 14 of FIG. 2. With reference to FIG. 8A, the modular accessory 18 includes an accessory mount 102 and an actuator 106 for selectively securing the accessory mount 102 in place. In the illustrated embodiment, the accessory mount 102 is a plate formed of HDPE. The accessory mount 102 defines a mounting aperture 110 that is configured to receive the actuator 106. Accessories may be mounted to the accessory mount 102 via machining methods. For example, bore holes may be drilled into the accessory mount 102 via a power tool, and accessories may then be mounted to the accessory mount 102 via fasteners received in the bore holes. In some uses, the modular accessory 18 may not require the accessory mount 102.

In the illustrated embodiment, with reference to FIG. 8A, the actuator 106 is a knob that includes a threaded stud 114. In other embodiments, the actuator 106 may be, for example, a fixed handle with an adjustable lock screw bolt, a thumb screw, a ratchet lever, a cam handle, a quick release clamp lever, or another similar type of actuator. The threaded stud 114 is insertable through the mounting aperture 110 of the accessory mount 102 and into the mounting adapter 66 to secure the accessory mount 102 to the mounting adapter 66. In other embodiments, as illustrated in FIG. 8B, an actuator 118 may include a threaded aperture 122 that is configured to receive the male threaded stud 94 from the mounting adapter 90 of FIG. 7B. With reference to FIGS. 8A and 8B, the actuators 106, 118 may be tightened and loosened to allow for movement of the accessory mount 102 relative to the mounting adapters 66, 90 and/or to allow for movement of the mounting adapters 66, 90 along the guide slot 74 (FIG. 6), as will be described in more detail. In some uses, the modular accessory 18 may not require the accessory mount 102 such that the actuators 106, 118 directly secure an accessory relative to the mounting adapter 66 of FIG. 7A or the mounting adapter 90 of FIG. 7B.

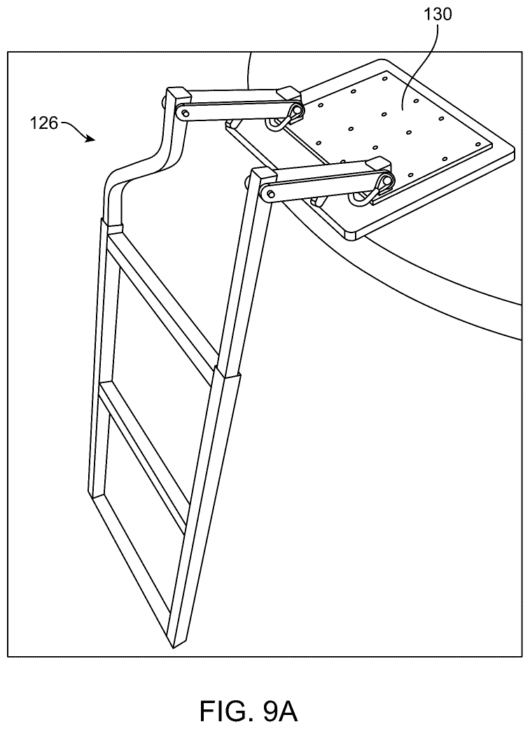

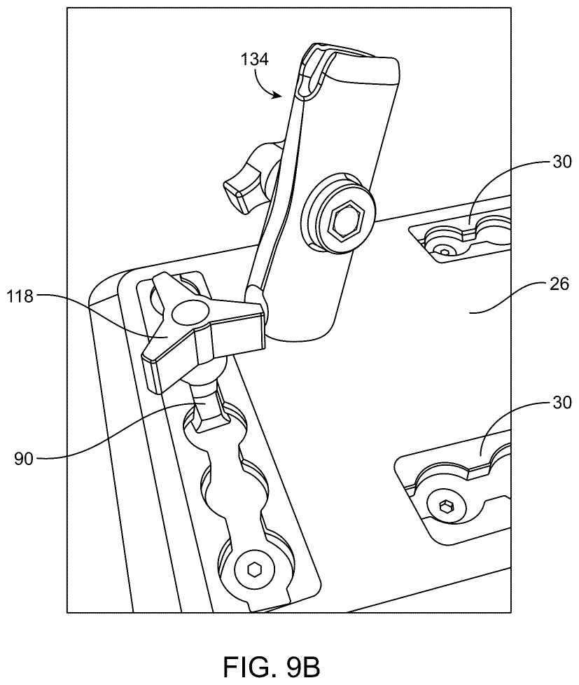

FIG. 9A illustrates an example of a first accessory 126 that may be mounted to the base gate 14 with the accessory mount 102. The first accessory 126 illustrated in FIG. 9A is a step ladder that includes a plate 130. With reference to FIGS. 8A and 9A, the plate 130 may be placed on the accessory mount 102 and fasteners may then be inserted through the plate 130 and into bore holes that have been machined into the accessory mount 102 to couple, or mount, the step ladder 126 to the accessory mount 102. The step ladder 126 may be oriented such that the step ladder 126 will hang down from a truck bed when the tailgate of the truck bed is open, thereby allowing a user to climb the step ladder 126 for ingress and egress into the truck bed. Although only one example of the first accessory 126 is illustrated in FIG. 9A, it is appreciated that any number of first accessories 126 may be mounted to the accessory mount 102 according to user preference. As such, examples of first accessories 126 include, but is not limited to, portable power supplies, tool boxes, tackle boxes, ski mounts, cable mounts, and power tool mounts.

FIG. 9B illustrates an example of a second accessory 134 that may be mounted to the base gate 14 without the use of the accessory mount 102. The second accessory 134 illustrated in FIG. 9B is a flag and/or umbrella holder. With reference to FIGS. 8B and 9B, the flag and/or umbrella holder 134 may include an aperture that is configured to receive the male threaded stud 94 from the mounting adapter 90 of FIG. 8B such that the male threaded stud 94 extends through the aperture. The actuator 118 may then be placed onto the male threaded stud 94 of the mounting adapter 90 to couple, or mount, the holder 134 to the mounting adapter 90, and therefore, to the base gate 14 (FIG. 2). Although only one example of the second accessory 134 is illustrated in FIG. 9B, it is appreciated that any number of second accessories 134 may be mounted to the mounting adapter 90 according to user preference. As such, examples of second accessories 134 include, but are not limited to, fishing pole holders, tool bit holders, and cup holders.

In some embodiments, the base gate 14 may further include a pocket, or basket, that is positioned within void space of a tailgate when the base gate 14 is installed onto the tailgate. Specifically, the tailgate may have a hollow interior that receives the pocket of the base gate 14. The pocket may then be accessible to a user to allow a user to store accessories within the pocket. For example, the pocket may enable a user to store excess/unused mounting adapters 66, 90, actuators 106, 118, and other similar items. In some instances, the pocket may be selectively scalable so that the items stored in the pocket do not fall out of the pocket regardless of the orientation of the tailgate.

To set up, or use, the modular mount system 10, a user may first install the base gate 14 onto/into a desired location on a user-operated vehicle. The modular mount system 10 may be installed with fasteners, such as the fasteners 42 of FIG. 5, or by another installation method. Specifically, in the illustrated embodiment, the base gate body 26 may be placed on and coupled to the surface of a movable component (e.g., the tailgate 6 of FIG. 1A, the rear doors 8 of FIG. 1B, etc.) of the user-operated vehicle. In other embodiments, the base gate body 26 may be placed on and coupled to the surface of a stationary component (e.g., a stationary wall of the truck bed 4 in FIG. 1A or of the van 2b in FIG. 1B) of the user-operated vehicle. With the base gate body 26 attached to the surface of the movable component, the guides 30 may be inserted into the guide receptacles 46, and the accessory plate 34 may be inserted into the accessory plate receptacle 50. Prior to inserting the guides 30 into the guide receptacles 46, one or multiple of the mounting adapters 66, 90 may be inserted into the guide slot 74 of each of the guides 30. The guides 30 may then be secured within the guide receptacles 46 and the accessory plate 34 may be secured within the accessory plate receptacle 50 via the fasteners 42.

For the sake of brevity, the attachment and adjustment of the modular accessory or accessories 18 is described with respect to just one modular accessory 18 and with respect to the to the mounting adapter 66 and the actuator 106 of FIG. 8A. However, it is understood that multiple modular accessories 18 may be attached to the base gate 14 and adjusted relative to the base gate 14 substantially similar to the description below with respect to the just one modular accessory 18. It is additionally understood that the description of the adjustment using the mounting adapter 90 and the actuator 118 of FIG. 8B may be substantially similar to the description of the mounting adapter 66 and the actuator 106 of FIG. 8A.

After the base gate body 26 is secured to the movable component of the user-operated vehicle, and the guides 30 and the accessory plate 34 are secured to the base gate body 26, the modular accessory 18 may be attached to the mounting adapter 66 as described above with respect to FIG. 8A. As such, the actuator 106 may be tightened to provide a movement inhibiting force on the modular accessory 18. Specifically, the actuator 106 may be tightened to secure the modular accessory 18 at any position along the guides 30 that is between a pair of the half-moon recesses 78. The actuator 106 may additionally be loosened to remove the movement inhibiting force on the modular accessory 18 to allow the mounting adapter 66, and thus the modular accessory 18, to slide along the guide 30. As such, the loosened actuator 106 enables a user to easily adjust the position of the modular accessory 18 along the guide 30. Once the modular accessory 18 is placed in a desired location along the guide 30, the actuator 106 may be tightened to re-secure the position of the modular accessory 18.

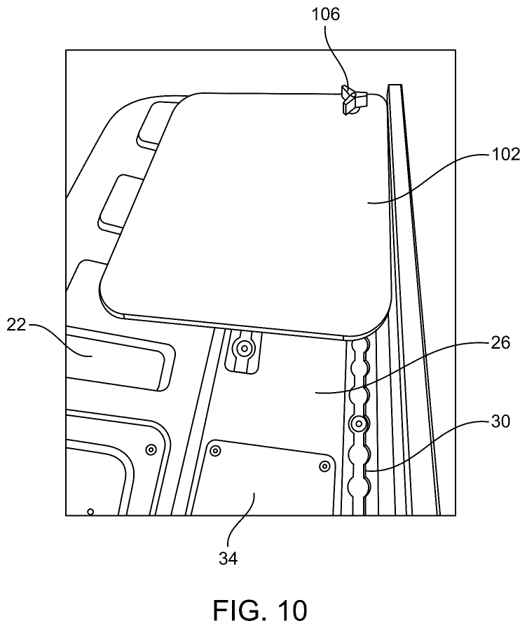

The modular accessory 18 is additionally adjustable between a storage position, as illustrated in FIG. 10, and a deployed position, as illustrated in FIG. 2. Specifically, the actuator 106 may be loosened to remove the movement inhibiting force from the modular accessory 18. With the actuator 106 loosened, the accessory mount 102 may be rotated about the threaded stud 114 of the actuator 106. As such, the accessory mount 102 may be rotated between the storage position, in which the accessory mount 102 substantially or at least partially overlaps the base gate body 26, as illustrated in FIG. 10, and the deployed position, in which the accessory mount 102 extends outwardly from the base gate body 26, as illustrated in FIG. 2 for example. In the illustrated embodiment, the accessory mount 102 fits entirely within the outer perimeter of the tailgate while in the storage position. In some embodiments, the accessory mount 102 may be relatively larger such that a portion of the accessory mount 102 protrudes from the perimeter of the tailgate (i.e., a portion of the accessory mount 102 does not overlap the tailgate). The deployed position may be any position in which accessory mount 102 is rotated between 0 and 360 degrees relative to the base gate body 26. However, in some uses, the rotational range of the accessory mount 102 may be limited by the structure that the base gate 14 is attached to. For example, side walls of a truck bed may limit the accessory mount 102 to a rotational range that is smaller than 0 and 360 degrees (e.g., between 5 and 180 degrees). In the storage position, the accessory mount 102 is oriented to optimize storage for the user-operated vehicle. In the deployed position, the accessory mount 102 is oriented to provide easy access to accessories for a user.

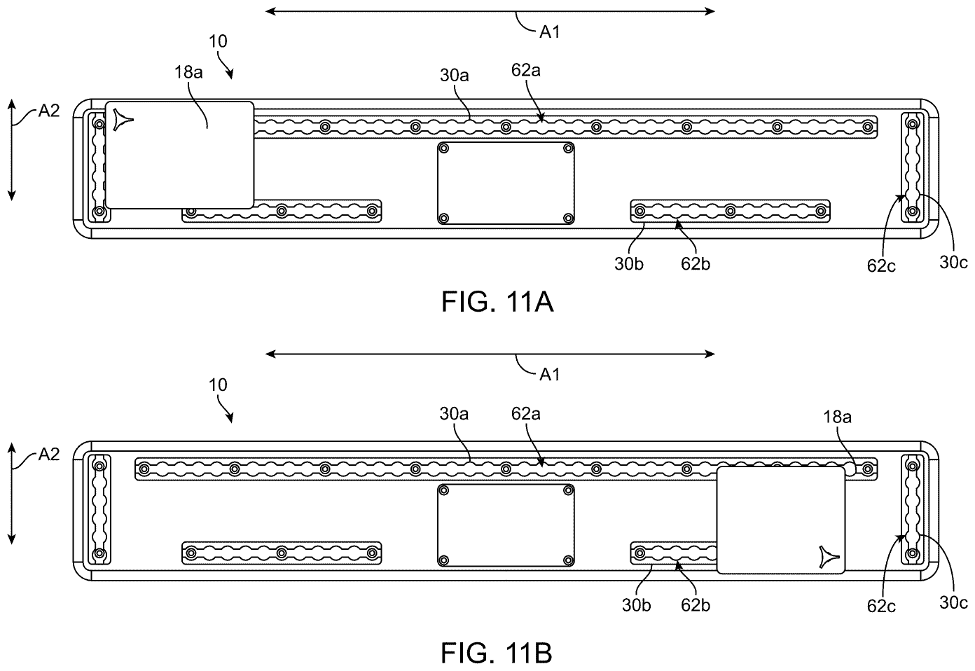

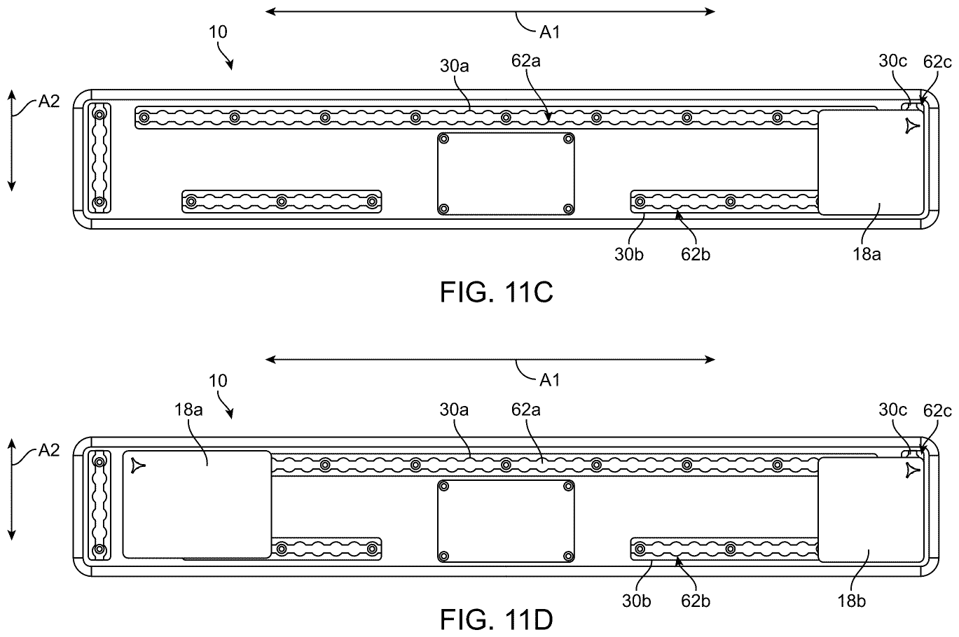

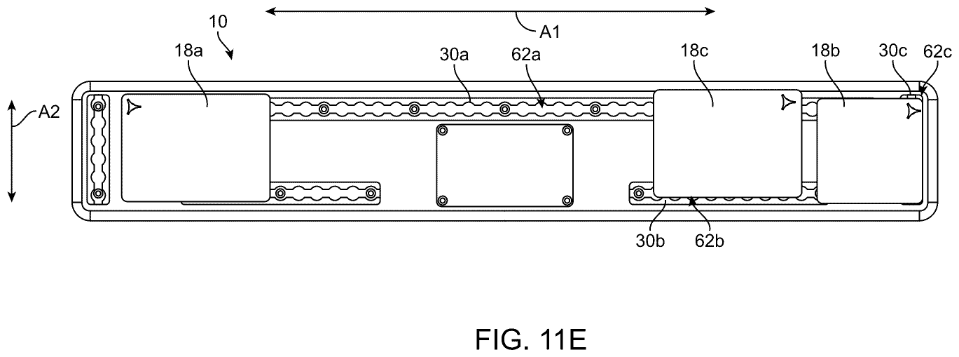

FIGS. 11A-11E illustrate multiple examples configurations of the modular mount system 10. The configurations of the modular mount system 10 illustrated in FIGS. 11A-11E are merely provided as examples of the uses of the modular mount system 10, and the modular mount system 10 is not limited to the configurations illustrated in FIGS. 11A-11E. As illustrated in FIGS. 11A-11E, the modular mount system 10 includes at least a first guide 30a having a first mounting interface 62a, a second guide 30b having a second mounting interface 62b, and a third guide 30c having a third mounting interface 62c. The first guide 30a and the first mounting interface 62a extend along the length direction A1. The second guide 30b and the second mounting interface 62b extend along the length direction A1 and are spaced from the first mounting interface 62a along the width direction A2. The third guide 30c and the third mounting interface 62c extend along the width direction A2 and are spaced from both the first mounting interface 62a and the second mounting interface 62b along the length direction A1.

FIG. 11A illustrates a first modular accessory 18a mounted to the first mounting interface 62a such that the first modular accessory 18a is configured to slide along the length direction A1. FIG. 11B illustrates the first modular accessory 18a mounted to the second mounting interface 62b such that the first modular accessory 18a is configured to slide along the length direction A1 at a position that is spaced from the first mounting interface 62a along the width direction A2. FIG. 11C illustrates the first modular accessory 18a mounted to the third mounting interface 62c such that the first modular accessory 18a is configured to slide along the width direction A2. FIG. 11D illustrates the first modular accessory 18a mounted to the first mounting interface 62a and a second modular accessory 18b mounted to the third mounting interface 62c. FIG. 11E illustrates the first modular accessory 18a mounted to the first mounting interface 62a, a second modular accessory 18b mounted to the third mounting interface 62c, and a third modular accessory 18c mounted to the first mounting interface 62a. Each of the modular accessories 18a-18c may be substantially similar to the modular accessory 18 described with respect to FIG. 8A.

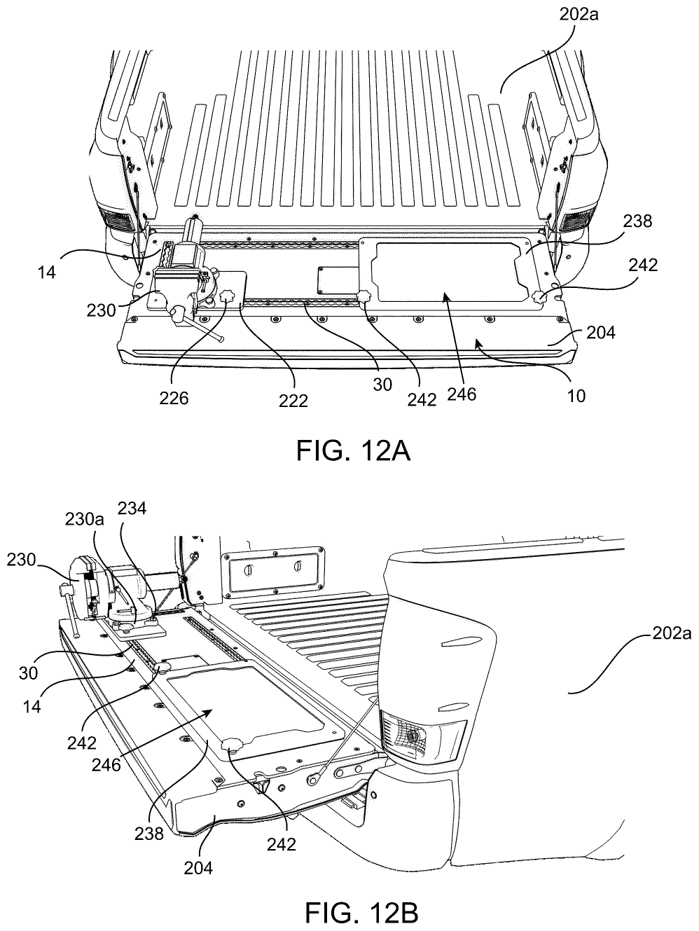

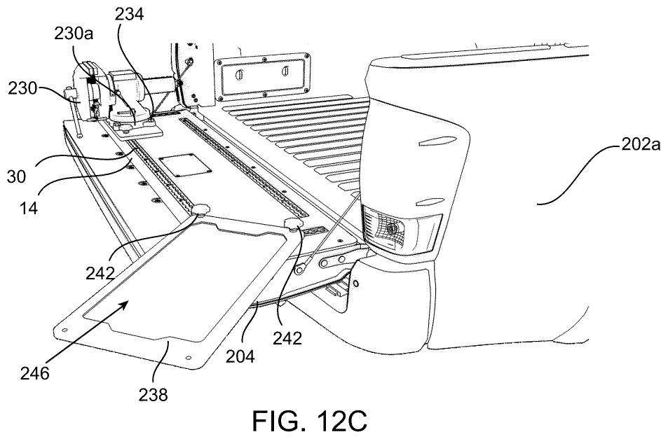

FIGS. 12A-12C illustrate another example configuration of the modular mount system 10. As illustrated in FIGS. 12A and 12B, modular mount system 10 is mounted to a truck 202a which may be substantially similar to the truck 2a illustrated in FIG. 1A. Specifically, the modular mount system 10 is mounted to a tailgate 204 of the truck 202a that may be movable between a stowed position and a deployed position. Although the tailgate 204 of the truck 202a is only illustrated in the deployed position in FIGS. 12A-12C, the stowed position of the tailgate 204 may be substantially similar to the orientation of the tailgate 6 illustrated in FIG. 1A.

The modular mount system 10 includes a first modular accessory 214 and a second modular accessory 218. The first modular accessory 214 includes a first accessory mount 222, a first actuator 226, and a vise clamp 230. The first accessory mount 222 may be substantially similar to the accessory mount 102 of FIG. 8A, except for a difference in relative scale. As such, the first accessory mount 222 is a plate formed of HDPE and defines at least one mounting aperture that is configured to receive the first actuator 226 for coupling the first accessory mount 222 to one of the guides 30 of the base gate 14. In the illustrated embodiment, the first accessory mount 222 is relatively smaller than the accessory mount 102 of FIG. 8A. The vise clamp 230 is installed on the first accessory mount 222 via bolts 234 that extend through a base 230a of the vise clamp 230 and into apertures that have been drilled into the first accessory mount 222. The vise clamp 230 is only an example of a utility item that can be attached to the first accessory mount 222, and the first modular accessory 214 is not limited to the use of the vise clamp 230 as the utility item that is attached to the first accessory mount 222.

The second modular accessory 218 includes a second accessory mount 238 and two second actuators 242. The second accessory mount 238 may be substantially similar to the first accessory mount 222, except for a difference in relative scale. Specifically, in the illustrated embodiment, the second accessory mount 238 is relatively larger than the first accessory mount 222. The second accessory mount 238 defines mounting apertures configured to receive the two second actuators 242 to couple the second accessory mount 238 to one of the guides 30 of the base gate 14. In the illustrated embodiment, the second accessory mount 238 defines a cutout 246 that may function as a tray for holding, or supporting, a variety of tools and accessories for a user. In some embodiments, a surface of the tray 246 may be magnetized to magnetically secure tools and accessories to the second accessory mount 238. The second accessory mount 238 is configured to be adjusted between a storage position, as illustrated in FIGS. 12A and 12B, and a deployed position, as illustrated in FIG. 12C. The second accessory mount 238 may be moved between the storage position and the deployed position substantially similarly as described with respect to the accessory mount 102 of FIG. 8A. However, in the illustrated embodiment, the second accessory mount 238 includes the two second actuators 242, which may provide additional support for the second accessory mount 238 in the deployed position. For example, as illustrated in FIGS. 12B and 12C, one of the second actuators 242 may be moved to a different mounting aperture defined in the second accessory mount 238 as the second accessory mount 238 is adjusted from the storage position to the deployed position to increase the amount of support or the second accessory mount 238 relative to the accessory mount 102 of FIG. 8A. It is understood that multiple actuators may be implemented with any of the modular accessories described herein based on the necessity for additional support for the modular accessory.

In use of the modular mount system 10, the modular mount system 10 may provide a user with a makeshift work bench that is deployable directly from the truck 202a. Although the configuration of the modular mount system 10 of FIGS. 12A-12C is described with respect to the attachment of the vise clamp 230 and the tray 246 (i.e., formed by the cutout of the second accessory mount 238), it is understood that any number of different tools, accessories, and other similar utility items may be implemented in the modular mount system 10 according to user preference and necessity. The modular mount system 10 therefore provides a user with a fast and simple way to store and deploy utility items in an organized manner through the attachment and adjustability of the utility items to a movable component of a vehicle via the base gate 14.

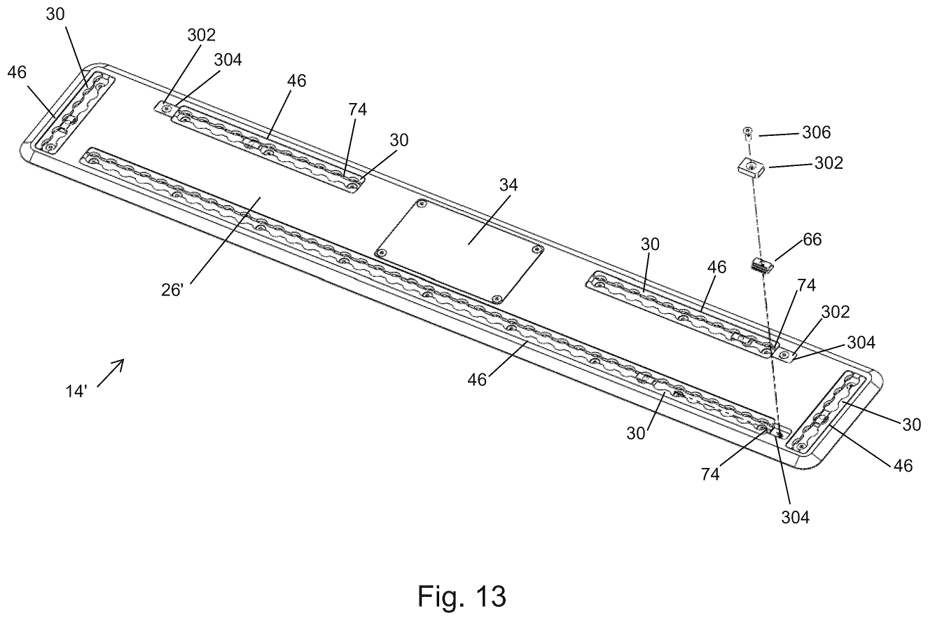

FIG. 13 illustrates an alternative base gate 14′ that is configured to facilitate installation of the mounting adapters 66, 90 within the guides 30. The alternative base gate 14′ is similar in size and shape to the base gate 14 and as such may be used in the same applications (e.g., being attached to the at least one modular accessory 18, being mounted to the tailgate 6 or the rear doors 8, and/or the like). For the sake of simplicity, this description will focus on differences in structure. It should be understood that any component not mentioned has the same structure and arrangement as described above with respect to the base gate 14.

The alternative base gate 14′ includes an alternative base gate body 26′, the plurality of guides 30, the accessory plate 34, and a plurality of stoppers 302. The alternative base gate body 26′, like the base gate body 26, includes the guide receptacles 46 for receiving the guides 30. Additionally, the alternative base gate body 26′ further includes a plurality of stopper receptacles 304 adjacent to and communicating with at least some of the guide receptacles 46. Furthermore, for reasons that will be explained below, each stopper receptacle 304 has substantially the same depth and width as the guide slots 74 of the guides 30, which also substantially matches the depth and width of the plurality of stoppers 302 and the mounting adapters 66, 90.

In use, while the guides 30 are secured in place within the guide receptacles 46, the mounting adapter 66 (or the mounting adapter 90) may be inserted into one of the stopper receptacles 304 and, because the stopper receptacle 302 is sized and arranged to communicate with the guide receptacle 46, may be slid along the guide slot 74 of the corresponding guide 30. Once the mounting adapter 66, 90 is in place within the guide 30 and to prevent inadvertent removal of the mounting adapter 66, 90 from the guide 30 via the adjacent stopper receptacle 304, one of the stoppers 302 may be inserted into stopper receptacle 304 and secured with a stopper fastener 306.

While, in this example, three stoppers 302 and three corresponding stopper receptacles 304 are shown, it should be understood that fewer or more stoppers 302 and corresponding stopper receptacles 304 may be provided.

Although the invention has been described in detail with reference to certain preferred embodiments, variations and modifications exist within the scope and spirit of one or more independent aspects of the invention as described. It will be appreciated that features described with regard to components of specific embodiments may be included in similar components described with regard to other embodiments.

1. A modular mount system for a vehicle, the modular mount system comprising:
a base gate attachable to a movable component of the vehicle, the base gate including a mounting interface; and
a modular accessory configured to be removably attached to the mounting interface.

2. The modular mount system of claim 1, wherein the mounting interface is a first mounting interface, wherein the base gate further includes a length extending along a length direction, a width extending along a width direction, and a second mounting interface, wherein the modular accessory is configured to be removably attached to both the first mounting interface and the second mounting interface, and wherein the second mounting interface is spaced from the first mounting interface along one of the length direction and the width direction.

3. The modular mount system of claim 1, wherein the base gate includes a base gate body that defines a guide receptacle and a guide that is received in the guide receptacle, and wherein the guide includes the mounting interface.

4. The modular mount system of claim 3, wherein the mounting interface includes a first edge, a second edge, and a guide slot defined between the first edge and the second edge, wherein the guide slot slidably receives a mounting adapter that is configured to slide along the guide slot, and wherein the modular accessory is configured to be removably attached to the mounting adapter such that the modular accessory is configured to slide along the guide slot with the mounting adapter.

5. The modular mount system of claim 4, wherein the modular accessory includes an actuator that is configured to be tightened to inhibit movement of the mounting adapter along the guide slot.

6. The modular mount system of claim 3, wherein the guide is removably attached to the base gate body within the guide receptacle via fasteners.

7. The modular mount system of claim 3, wherein the guide is one of a plurality of guides, wherein each guide of the plurality of guides includes a mounting interface, and wherein the mounting interface of each of the plurality of guides is configured to receive the modular accessory.

8. The modular mount system of claim 7, wherein at least one of the guides of the plurality of guides is longer than another of the guides of the plurality of guides.

9. The modular mount system of claim 1, wherein the vehicle is a truck including a truck bed, and wherein the movable component is a tailgate of the truck bed.

10. The modular mount system of claim 1, wherein the base gate includes base gate body that defines an accessory plate receptacle and an accessory plate that is configured to be received in the accessory plate receptacle, wherein a bottom surface of the accessory plate receptacle defines at least one magnetic aperture configured to receive at least one magnet that creates a magnetic field such that accessories are attachable to the accessory plate via a magnetic connection.

11. A modular mount system for a vehicle, the modular mount system comprising:
a base gate attachable to the vehicle, the base gate including a mounting interface that extends along a first direction of the base gate; and
a modular accessory configured to be removably attached to the mounting interface, the modular accessory movable within the mounting interface to multiple positions along the first direction of the base gate.

12. The modular mount system of claim 11, wherein the modular accessory includes a lock that is configured to secure the modular accessory in each of the multiple positions along the first direction of the base gate such that the lock inhibits movement of the modular accessory within the mounting interface.

13. The modular mount system of claim 11, wherein the modular accessory is rotatable between a storage position in which the modular accessory overlaps the base gate and a deployed position.

14. The modular mount system of claim 13, wherein the modular accessory includes a lock that is configured to secure the modular accessory in each of the storage position and the deployed position such that the lock inhibits rotation of modular accessory to the other of the storage position and the deployed position.

15. The modular mount system of claim 13, wherein the deployed position includes any position of the modular accessory in which the modular accessory has been rotated between 0 and 360 degrees relative to the storage position.

16. The modular mount system of claim 11, wherein the mounting interface is a first mounting interface, wherein the base gate further includes a second mounting interface that is spaced from the first mounting interface along a second direction of the base gate, and wherein the modular accessory is configured to be attached to both the first mounting interface and the second mounting interface.

17. The modular mount system of claim 16, wherein the base gate further includes a third mounting interface that is spaced from the first mounting interface and the second mounting interface along the first direction of the base gate, and wherein the modular accessory is configured to be removably attached to the third mounting interface.

18. A modular mount system for a vehicle, the modular mount system comprising:
a base gate attachable to the vehicle, the base gate including
a length that extends along a length direction,
a width extending along a width direction,
a first mounting interface that extends along the length direction, and
a second mounting interface that extends along the width direction;
a first modular accessory configured to be removably attached to the first mounting interface, the first modular accessory movable within the first mounting interface to multiple positions along the length direction of the base gate; and
a second modular accessory configured to be removably attached to the second mounting interface, the second modular accessory movable within the second mounting interface to multiple positions along the width direction of the base gate.

19. The modular mount system of claim 18, further comprising a third modular accessory configured to be removably attached to the first mounting interface, the third modular accessory movable within the first mounting interface to multiple positions along the length direction of the base gate.

20. The modular mount system of claim 18, wherein the base gate is attachable to a movable component of the vehicle.
